(19) United States
(12) Patent Application Publication
(10) Pub. No.: US 2021/0341352 A1
(43) Pub. Date: Nov. 4, 2021

(54) DIAGNOSIS APPARATUS, DIAGNOSIS METHOD, AND COMPUTER READABLE RECORDING MEDIUM

(71) Applicant: NEC Corporation, Minato-ku, Tokyo (JP)

(72) Inventors: Shohei KINOSHITA, Tokyo (JP); Shigeru KASAI, Tokyo (JP); Yu KIYOKAWA, Tokyo (JP)

(73) Assignee: NEC Corporation, Minato-ku, Tokyo (JP)

(21) Appl. No.: 17/271,258

(22) PCT Filed: Aug. 31, 2018
(86) PCT No.: PCT/JP2018/032482

§ 371 Date: Feb. 25, 2021

(51) Int. Cl. G01M 7/02; G01M 5/00

(52) U.S. Cl. CPC G01M 7/025; G01M 5/0008

(57) ABSTRACT

A diagnosis apparatus 1 includes: a generation unit 2 configured to acquire vibration information indicating vibration produced in a structure 20 from a plurality of sensors 21 provided to the structure 20, and to generate, using the vibration information, natural vibration mode information indicating a natural vibration mode shape; an occurrence rate calculation unit 3 configured to calculate a rate of occurrence of a normal natural vibration mode shape based on the number of times vibration was applied to the structure 20 and the number of times the normal natural vibration mode shape was generated when the vibration was applied; and a diagnosis unit 4 configured to diagnose whether or not repair and reinforcement performed on the structure were effective based on the rate of occurrence and a reference value.

### TECHNICAL FIELD

The present invention relates to a diagnosis apparatus and a diagnosis method that are used to diagnose a structure, and furthermore, relates to a computer readable recording medium that includes a program for realizing the diagnosis apparatus and the diagnosis method recorded thereon.

### BACKGROUND ART

In recent years, the deterioration of bridges over years has become a social problem, and construction for repairing and reinforcing deteriorated bridges is being carried out. Furthermore, if such construction is carried out on a bridge, it is important to diagnose whether or not the bridge exhibits a positive effect produced by the repair and reinforcement involved in the construction.

As a related technique, Patent Document 1 discloses a soundness assessment device for accurately assessing the soundness of bridge piers. According to the soundness assessment device that is disclosed, acceleration amplitudes in the bridge axis direction and acceleration amplitudes in a bridge axis orthogonal direction that is perpendicular to the bridge axis direction are acquired when a vehicle passes over a bridge or a viaduct. Furthermore, the soundness assessment device calculates an acceleration amplitude ratio by dividing the maximum acceleration amplitude value in the bridge axis orthogonal direction by the maximum acceleration amplitude value in the bridge axis direction, and diagnoses the soundness of a bridge pier using the acceleration amplitude ratio.

In addition, Patent Document 2 discloses a signal processing method that can be used to diagnose degradation of bridge pier strength. According to the signal processing method that is disclosed, a natural frequency is calculated using a signal produced by vibration of a bridge pier, and degradation of strength is diagnosed based on a comparison between the natural frequency and a reference value.

Furthermore, Patent Document 3 discloses a countermeasure effect determination device that determines the effect of an earthquake countermeasure applied to a structure. According to the countermeasure effect determination device that is disclosed, spectral conversion is performed on pieces of time-domain data relating to microtremor, which are acquired from microtremor of a structure before and after a countermeasure is applied, and a spectral ratio is calculated using the spectra obtained through the conversion. Furthermore, a diagnosis of whether or not the countermeasure for repair and reinforcement was effective is performed using the relationship between the spectral ratio and vibration frequencies.

Also, Non-Patent Document 1 proposes a method for diagnosing the effect of repair and reinforcement performed on a bridge. According to Non-Patent Document 1, the measurement of deflection (displacement), etc., are used as methods for diagnosing repair and reinforcement performed on a concrete floor slab of a bridge.

### LIST OF RELATED ART DOCUMENTS

### Patent Document

Patent Document 1: Japanese Patent Laid-Open Publication No. 2015-078554
Patent Document 2: Japanese Patent Laid-Open Publication No. 2007-270552
Patent Document 3: Japanese Patent Laid-Open Publication No. H10-253491

### Non-Patent Document

Non-Patent Document 1: Tomonori, Ichikawa et al., “Repair and reinforcement of bridge deck having horizontal internal cracks”, Proceeding of Symposium on Decks of Highway Bridge, June 2012, pp. 111-117

### SUMMARY OF INVENTION

### Problems to be Solved by the Invention

However, in Patent Document 1, the soundness of a bridge is diagnosed using an acceleration amplitude ratio. Furthermore, in Patent Document 2, the degradation of the strength of a bridge is diagnosed using a natural frequency. In addition, in Patent Document 3, repair and reinforcement performed on a structure are diagnosed using a relationship between a spectral ratio and vibration frequencies. Accordingly, in the case of a bridge or the like, which is a structure having high rigidity, repair and reinforcement that have been performed cannot be accurately diagnosed even if Patent Documents 1 to 3 are used.

Similarly, with regard to Non-Patent Document 1, accurate diagnosis cannot be performed by measuring deflection in a bridge having small deflection. That is, in the case of a bridge or the like, which is a structure having high rigidity or, in other words, small deflection, repair and reinforcement that have been performed cannot be accurately diagnosed.

One example object of the invention is to provide a diagnosis apparatus, a diagnosis method, and a computer readable recording medium for accurately diagnosing a structure.

### Means for Solving the Problems

In order to achieve the above-described object, a diagnosis apparatus according to an example aspect of the invention includes:

a generation unit configured to acquire vibration information indicating vibration produced in a structure from a plurality of sensors provided to the structure, and to generate, using the vibration information, natural vibration mode information indicating a natural vibration mode shape;

an occurrence rate calculation unit configured to calculate a rate of occurrence of a normal natural vibration mode shape based on the number of times vibration was applied to the structure and the number of times the normal natural vibration mode shape was generated when the vibration was applied; and

a diagnosis unit configured to diagnose whether or not repair and reinforcement performed on the structure were effective based on the rate of occurrence and a reference value.

In addition, in order to achieve the above-described object, a diagnosis method according to an example aspect of the invention includes:

(a) a step of acquiring vibration information indicating vibration produced in a structure from a plurality of sensors provided to the structure, and generating a natural vibration mode shape using the vibration information;

(b) a step of calculating a rate of occurrence of a natural vibration mode shape based on the number of times vibration was applied to the structure and the number of times the normal natural vibration mode shape was generated when the vibration was applied; and

(c) a step of diagnosing whether or not repair and reinforcement performed on the structure were effective based on the rate of occurrence and a reference value.

Furthermore, in order to achieve the above-described object, a computer readable recording medium that includes a program recorded thereon according to an example aspect of the invention includes recorded thereon a program that causes a computer to carry out:

(a) a step of acquiring vibration information indicating vibration produced in a structure from a plurality of sensors provided to the structure, and generating a natural vibration mode shape using the vibration information;

(b) a step of calculating a rate of occurrence of a natural vibration mode shape based on the number of times vibration was applied to the structure and the number of times the normal natural vibration mode shape was generated when the vibration was applied; and

(c) a step of diagnosing whether or not repair and reinforcement performed on the structure were effective based on the rate of occurrence and a reference value.

### Advantageous Effects of the Invention

As described above, according to the invention, a structure can be accurately diagnosed.

### BRIEF DESCRIPTION OF THE DRAWINGS

FIG. 1 is a diagram illustrating one example of a diagnosis apparatus.

FIG. 2 is a diagram illustrating one example of a system including the diagnosis apparatus.

FIG. 3 is a diagram illustrating one example of acceleration measured by a sensor.

FIG. 4 is a diagram showing the acceleration in the frequency domain that is converted from that in the time domain.

FIG. 5 is a diagram illustrating one example of a natural vibration mode shape.

FIG. 6 is a diagram illustrating one example of operations of the diagnosis apparatus.

FIG. 7 is a diagram illustrating one example of operations of the diagnosis apparatus.

FIG. 8 is a diagram illustrating one example of a computer realizing the diagnosis apparatus.

### EXAMPLE EMBODIMENT

### Example Embodiment

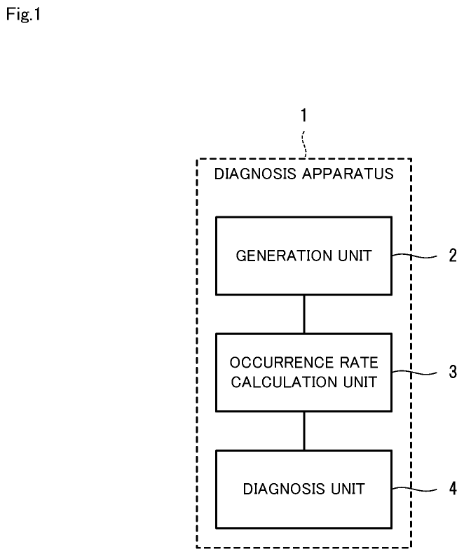

In the following, an example embodiment of the invention will be described with reference to FIGS. 1 to 8.

[Apparatus Configuration]

First, a configuration of a diagnosis apparatus 1 in the present example embodiment will be described with reference to FIG. 1. FIG. 1 is a diagram illustrating one example of the diagnosis apparatus 1.

The diagnosis apparatus 1 illustrated in FIG. 1 is an apparatus for accurately diagnosing a structure. Furthermore, as illustrated in FIG. 1, the diagnosis apparatus 1 includes a generation unit 2, an occurrence rate calculation unit 3, and a diagnosis unit 4.

Among these units, the generation unit 2 acquires vibration information indicating vibration produced in a structure from a plurality of sensors provided to the structure, and generates, using the vibration information, natural vibration mode information indicating a natural vibration mode shape. Note that the structure is a hardened material (concrete, mortar, or the like) that is solidified using at least sand, water, and cement, a metal, or a structure constructed using such materials. Also, the structure is an entirety or part of an architectural structure. Furthermore, the structure is an entirety or part of a machine.

The occurrence rate calculation unit 3 calculates a rate of occurrence of a normal natural vibration mode shape based on the number of times vibration was applied to the structure and the number of times the normal natural vibration mode shape was generated when the vibration was applied. Note that it is desirable to use a primary vibration mode or the like, for example, as the natural vibration mode.

The diagnosis unit 4 diagnoses whether or not repair and reinforcement performed on the structure were effective based on the rate of occurrence and a reference value. Specifically, the diagnosis unit 4 uses a rate of occurrence calculated in advance before repair and reinforcement were performed on the structure as the reference value, and diagnoses whether or not the repair and reinforcement of the structure were effective based on the reference value and a rate of occurrence calculated after the repair and reinforcement were performed.

In such a manner, in the present example embodiment, it can be diagnosed whether or not repair and reinforcement performed on a structure were effective using rates of occurrence calculated using natural vibration mode shapes, and thus the effect of the repair and reinforcement performed on the structure can be accurately diagnosed even if the structure has high rigidity. Accordingly, a structure can be diagnosed with higher accuracy compared to when the devices disclosed in Patent Documents 1 to 3 and Non-Patent Document 1 are used.

[System Configuration]

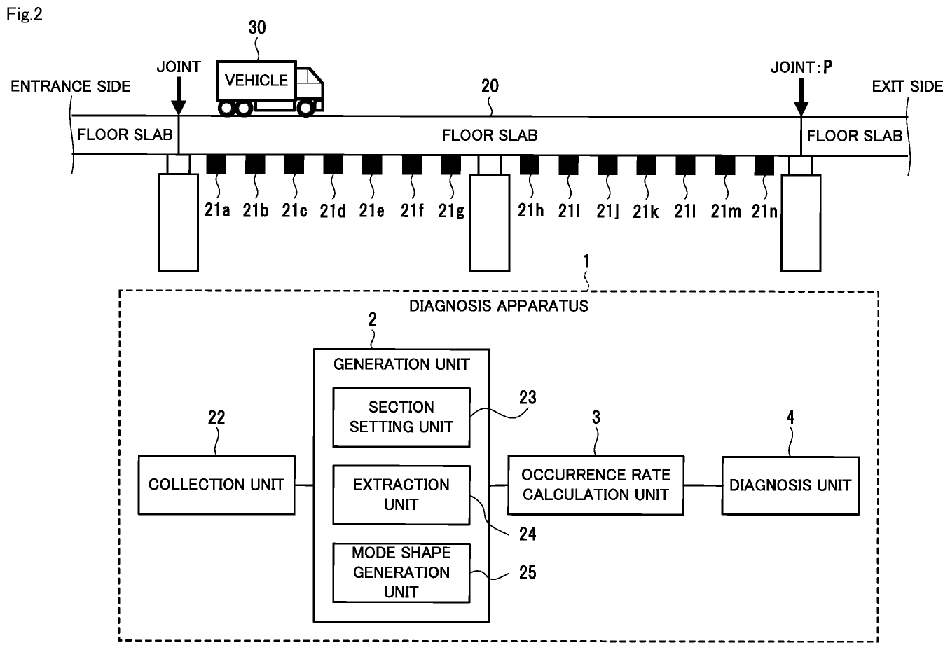

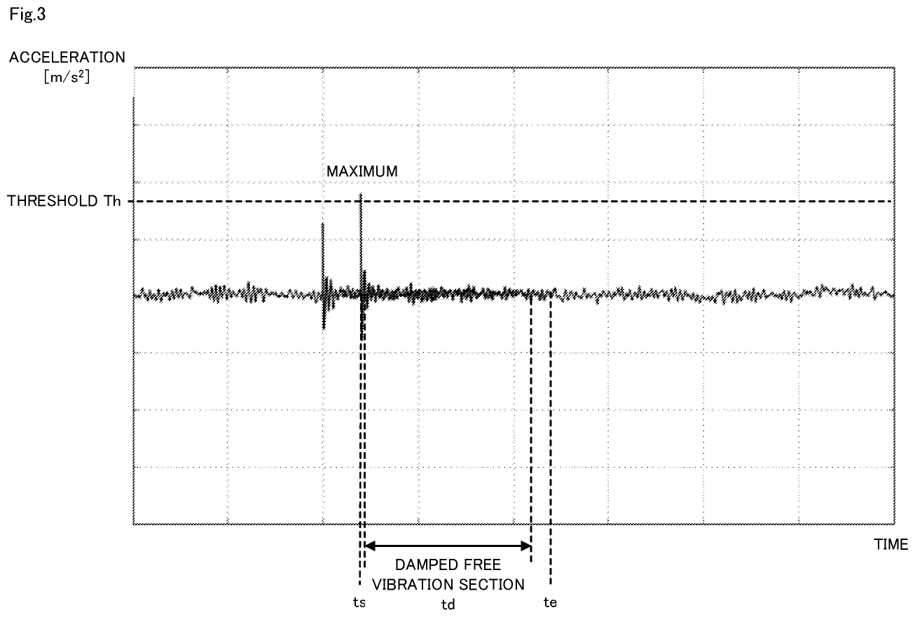

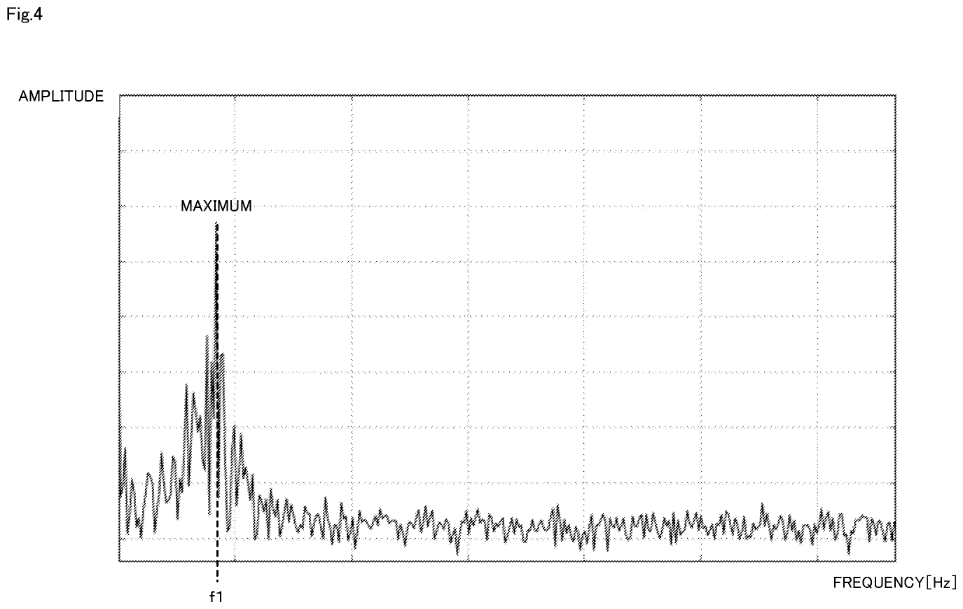

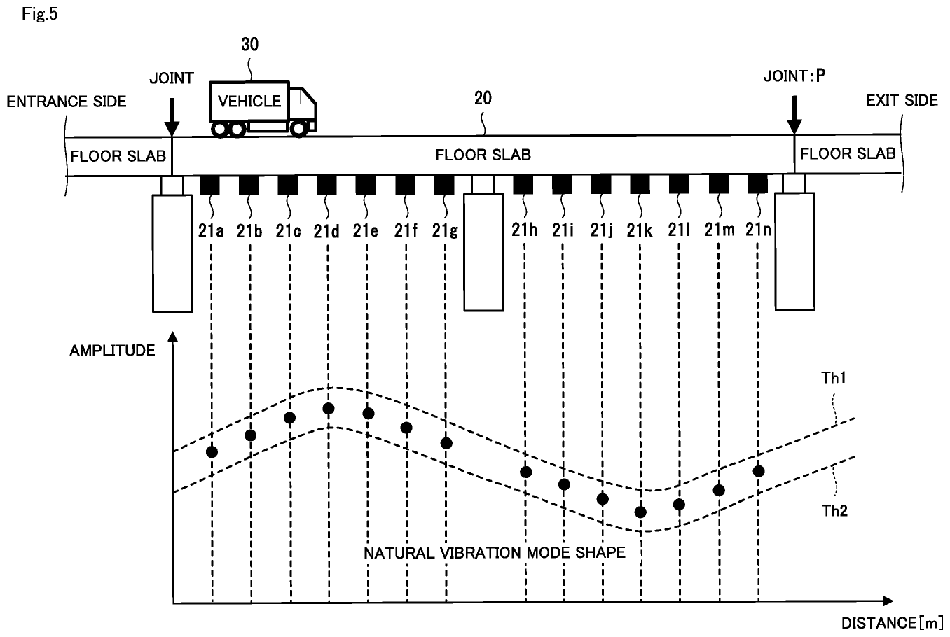

Next, the diagnosis apparatus 1 in the present example embodiment will be specifically described with reference to FIGS. 2, 3, 4, and 5. FIG. 2 is a diagram illustrating one example of a system including the diagnosis apparatus. FIG. 3 is a diagram illustrating one example of acceleration measured by a sensor. FIG. 4 is a diagram showing the acceleration in the frequency domain that is converted from that in the time domain. FIG. 5 is a diagram illustrating one example of a natural vibration mode shape.

As illustrated in FIG. 2, the system in the present example embodiment includes a plurality of sensors 21 (sensors 21a to 21n), and a collection unit 22, in addition to the generation unit 2, the occurrence rate calculation unit 3, and the diagnosis unit 4. Note that the generation unit 2 includes a section setting unit 23, an extraction unit 24, and a mode shape generation unit 25.

In the system illustrated in FIG. 2, vibration is applied to a structure 20 (floor slab) multiple times by causing a vehicle 30 to travel over the structure 20 multiple times from an entrance side to an exit side. Furthermore, when the vehicle 30 passes over a joint P in the example in FIG. 2, the structure 20 vibrates due to impact being applied to the structure 20 with the joint P serving as a fulcrum.

In the example in FIG. 2, the structure 20 is a floor slab of a multi-span structure bridge. However, the member constituting the structure 20 is not limited to a floor slab. Also, the vehicle 30 is a device used to apply vibration to the structure 20. However, the device for applying vibration is not limited to the vehicle 30. The device for applying vibration may be a vibration generator that is prepared in advance, for example. Alternatively, vibration may be applied by dropping a weight that is prepared in advance. However, there is no limitation to the above-described methods.

The sensors 21 are attached to the structure 20, and measure at least the magnitude of vibration of the structure 20 and transmit signals including vibration information indicating the measured magnitude of vibration to the diagnosis apparatus 1. For example, the use of triaxial acceleration sensors, fiber sensors, etc., is conceivable.

Specifically, as illustrated in FIG. 2, the plurality of sensors 21 attached to the structure 20 each measure acceleration at the position to which the sensor is attached. Following this, the plurality of sensors 21 each transmit, to the diagnosis apparatus 1, a signal including vibration information indicating the measured acceleration. Note that wired or wireless communication or the like is used for the communication between each of the sensors 21 and the diagnosis apparatus 1. Furthermore, vibration information is information in which acceleration and the date/time the acceleration was measured are associated with one another.

The collection unit 22 receives vibration information transmitted via wired or wireless communication or the like from each of the plurality of sensors 21 attached to the structure 20. Subsequently, the collection unit 22 outputs the vibration information that the collection unit 22 has collected to the generation unit 2.

The generation unit 2 sets a damped free vibration section to each piece of vibration information collected from the sensors 21. Furthermore, the generation unit 2 converts amplitude information within the damped free vibration sections that have been set from the time domain into the frequency domain. Subsequently, the generation unit 2 generates natural vibration mode information indicating a natural vibration mode shape, using amplitude/phase information of a frequency having the maximum amplitude among the amplitudes of respective frequencies within the converted damped free vibration sections.

Specifically, the section setting unit 23 included in the generation unit 2 first acquires, from the collection unit 22, vibration information indicating the acceleration measured by each of the sensors 21a to 21n. Following this, the section setting unit 23 determines whether or not the acceleration measured by the sensor 21n has exceeded a threshold Th. If the acceleration has exceeded the threshold Th, the section setting unit 23 sets, as a damped free vibration section td, a section included within the period from the time point (start date/time ts) when the acceleration exceeded the threshold Th to the time point (end date/time te) after the elapse of a predetermined amount of time from the start date/time ts. Following this, the section setting unit 23 also sets a damped free vibration section td to the vibration information measured by each of the sensors 21a to 21m.

In a case in which the waveform illustrated in FIG. 3 is a waveform measured by the sensor 21n, a damped free vibration section td is set within the period from the time point (start date/time ts) when the acceleration exceeded the threshold Th to the time point (end date/time te) after the elapse of the predetermined amount of time from the start date/time ts. In addition, the section setting unit 23 also sets a damped free vibration section td to the vibration information measured by each of the sensors 21a to 21m.

Next, the extraction unit 24 included in the generation unit 2 performs conversion (a Fourier transform or the like, for example) from the time domain into the frequency domain on amplitude information (acceleration) within the damped free vibration section set for each of the sensors 21a to 21n. Furthermore, for each of the sensors 21a to 21n, the extraction unit 24 extracts a frequency having an amplitude greater than or equal to a predetermined value.

In a case in which the waveform illustrated in FIG. 4 is a waveform obtained by converting amplitudes within a damped free vibration section corresponding to one of the sensors 21a to 21n into the frequency domain, the extraction unit 24 extracts a frequency f1 (±α) having the maximum amplitude. A frequency shifted from the frequency f1 by a predetermined frequency α can be regarded as being the frequency f1, considering the predetermined frequency α as a measurement error or the like. It is desirable for the frequency having the maximum amplitude, for example, to be extracted as the frequency f1, but the extracted frequency f1 need not be the frequency corresponding to the maximum.

Next, the mode shape generation unit 25 included in the generation unit 2 generates a natural vibration mode shape using, for the frequency f1 extracted for each of the sensors 21a to 21n, amplitude/phase information relating to the extracted frequency f1. For example, the mode shape generation unit 25 generates a natural vibration mode shape corresponding to the sensors 21a to 21n, as illustrated in FIG. 5.

The occurrence rate calculation unit 3 uses the number of times vibration was applied to the structure 20 and the number of times a normal natural vibration mode shape was generated in response to the vibration, and generates a rate of occurrence of the natural vibration mode shape. Specifically, the occurrence rate calculation unit 3 first determines whether or not the generated natural vibration mode shape is similar to a reference natural vibration mode shape that is set in advance.

The occurrence rate calculation unit 3 determines that the natural vibration mode occurred if the generated natural vibration mode shape is similar to the reference natural vibration mode shape. Here, the generated natural vibration mode shape is regarded as being similar to the reference natural vibration mode shape set in advance if the generated natural vibration mode shape is included within the area between a threshold Th1 and a threshold Th2 (the area between the broken lines) illustrated in FIG. 5, for example.

Alternatively, the generated natural vibration mode shape is regarded as being similar to the reference natural vibration mode shape set in advance if the modal assurance criteria (MAC) between the reference natural vibration mode shape and the generated natural vibration mode shape is greater than a predetermined threshold, for example. However, there is no limitation to the above-described methods.

Following this, the occurrence rate calculation unit 3 generates a rate of occurrence (M/N×100(%)) of the natural vibration mode shape using the number of times N the vehicle 30 traveled on the structure 20 (the number of times vibration was applied) and the number of times M the natural vibration mode shape was generated in response to the vibration. Note that the rate of occurrence may also be a ratio (M/N) or the like.

The diagnosis unit 4 uses a rate of occurrence calculated in advance before repair and reinforcement were performed on the structure 20 as a reference value, and diagnoses whether or not the repair and reinforcement of the structure 20 were effective based on the reference value and a rate of occurrence calculated after the repair and reinforcement were performed on the structure 20. Specifically, the diagnosis unit 4 diagnoses that the repair and reinforcement of the structure 20 were effective if the rate of occurrence of the natural vibration mode shape is higher than the reference value.

This is because, due to the structure 20 being in an abnormal state before repair and reinforcement are performed on the structure 20, the reference natural vibration mode shape is rarely generated, and thus the rate of occurrence of the natural vibration mode shape is low. In contrast, due to the structure 20 being in a normal state after repair and reinforcement are performed on the structure 20, the rate of occurrence of the natural vibration mode shape is high.

[Apparatus Operations]

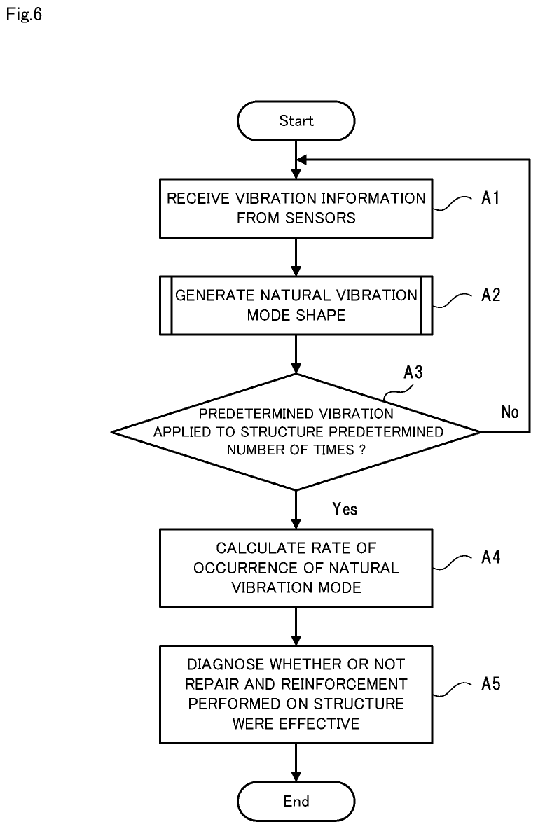

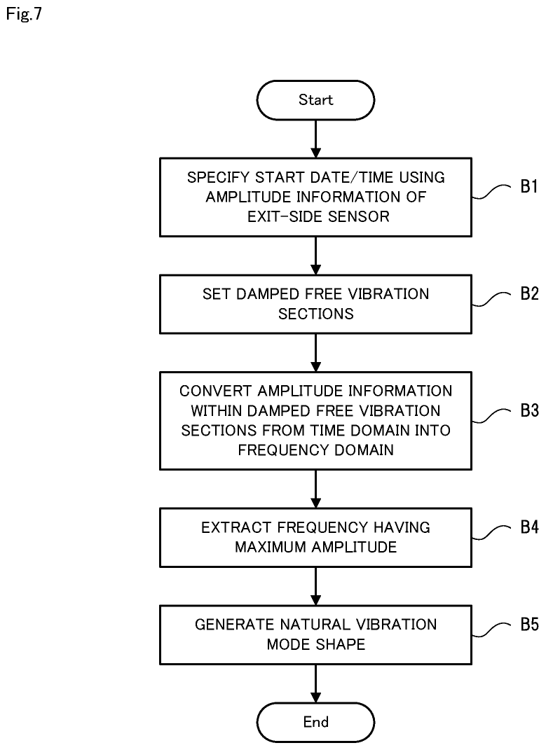

Next, operations of the diagnosis apparatus 1 in the example embodiment of the invention will be described with reference to FIGS. 6 and 7. FIGS. 6 and 7 are diagrams each illustrating one example of operations of the diagnosis apparatus. FIGS. 2 to 5 will be referred to as needed in the following description. Also, in the present example embodiment, a diagnosis method is implemented by causing the diagnosis apparatus 1 to operate. Accordingly, the following description of the operations of the diagnosis apparatus 1 is substituted for the description of the diagnosis method in the present example embodiment.

As illustrated in FIG. 6, the collection unit 22 receives vibration information indicating vibration (acceleration, etc., for example) occurring in the structure 20 from the plurality of sensors 21 (sensors 21a to 21n) provided to the structure 20 (step A1).

Following this, the generation unit 2 sets a damped free vibration section for each of the sensors 21 using the collected vibration information. Furthermore, the generation unit 2 converts amplitude information within the damped free vibration sections that have been set from the time domain into the frequency domain. Subsequently, the generation unit 2 extracts a frequency having an amplitude greater than or equal to a predetermined value from among the amplitudes of respective frequencies within the damped free vibration sections, and generates a natural vibration mode shape using amplitude/phase information relating to the extracted frequency (step A2). The details of step A2 will be described below with reference to FIG. 7.

The processing in step A2 will be described in detail.

In step B1 in FIG. 7, the section setting unit 23 specifies a start date/time using amplitude information of the exit-side sensor 21n provided to the structure 20. Specifically, as illustrated in FIG. 3, the section setting unit 23 determines whether or not the acceleration measured by the exit-side sensor 21n has exceeded a threshold Th.

In step B2, if the acceleration has exceeded the threshold Th, the section setting unit 23 sets, as a damped free vibration section td, a period included within the period from the time point (start date/time ts) when the acceleration exceeded the threshold Th to the time point (end date/time te) after the elapse of a predetermined amount of time from the start date/time ts. For example, in a case in which the waveform illustrated in FIG. 3 is a waveform measured by the sensor 21n, the section setting unit 23 sets a damped free vibration section within the period following the start date/time ts when the acceleration exceeded the threshold Th and ending at the end date/time te. Furthermore, the section setting unit 23 also sets a damped free vibration section td for each of the sensors 21a to 21m.

In step B3, the extraction unit 24 performs conversion from the time domain into the frequency domain on amplitude information (acceleration) within the damped free vibration section set for each of the sensors 21a to 21n. Following this, in step B4, for each of the sensors 21a to 21n, the extraction unit 24 extracts a frequency having an amplitude greater than or equal to a predetermined value. In the case of a waveform corresponding to one of the sensors 21a to 21n as illustrated in FIG. 4, the extraction unit 24 extracts a frequency f1 having the maximum amplitude, for example.

In step B5, the mode shape generation unit 25 generates a natural vibration mode shape using, for the frequency extracted for each of the sensors 21a to 21n, amplitude/phase information of the extracted frequency. For example, the mode shape generation unit 25 generates a natural vibration mode shape corresponding to the sensors 21a to 21n, as illustrated in FIG. 5.

Next, the generation unit 2 determines whether or not vibration has been applied to the structure 20 a predetermined number of times M. If vibration has been applied the predetermined number of times M (step A3: Yes), the generation unit 2 shifts to the processing in step A4 (step A3). If vibration has not been applied the predetermined number of times M yet (step A3: No), the generation unit 2 shifts to the processing in step A1 (step A3).

Next, the occurrence rate calculation unit 3 calculates a rate of occurrence of the natural vibration mode shape based on the number of times M vibration was applied to the structure 20 and the number of times N the normal natural vibration mode shape was generated in response to the vibration (step A4).

The processing in step A4 will be specifically described.

In step A4, the occurrence rate calculation unit 3 first determines whether or not the generated natural vibration mode shape is similar to a reference natural vibration mode shape that is set in advance.

Following this, the occurrence rate calculation unit 3 determines that the natural vibration mode has occurred if the generated natural vibration mode shape is similar to the reference natural vibration mode shape. For example, this corresponds to the case illustrated in FIG. 5, in which the natural vibration mode shape is included within the area between a threshold Th1 and a threshold Th2 (the area between the broken lines) that have been set in advance, etc.

Following this, the occurrence rate calculation unit 3 generates a rate of occurrence (M/N×100(%)) of the natural vibration mode shape using the number of times N the vehicle 30 traveled on the structure 20 (the number of times vibration was applied) and the number of times M the natural vibration mode shape was generated in response to the vibration. Note that the rate of occurrence may also be a ratio (M/N) or the like.

Next, the diagnosis unit 4 uses a rate of occurrence calculated in advance before repair and reinforcement were performed on the structure 20 as a reference value, and diagnoses whether or not the repair and reinforcement of the structure 20 were effective based on the reference value and a rate of occurrence calculated after the repair and reinforcement were performed on the structure 20 (step A5).

Specifically, the diagnosis unit 4 diagnoses that the repair and reinforcement of the structure 20 were effective if the rate of occurrence of the natural vibration mode shape is higher than the reference value. For example, if the rate of occurrence of the normal natural vibration mode shape is 100(%) and the reference value is 65(%), the diagnosis unit 4 diagnoses that the repair and reinforcement of the structure 20 were effective because the rate of occurrence (100(%)) is higher than the reference value (65(%)).

[Modification 1]

Modification 1 will be described. In modification 1, a rate of occurrence that is calculated for another structure having a structure similar to that of the structure 20 and that is calculated before repair and reinforcement were performed on the other structure is used as a reference value. Based on this reference value and a rate of occurrence calculated after repair and reinforcement were performed on the structure 20, the diagnosis unit 4 diagnoses whether or not the repair and reinforcement of the structure 20 were effective. Specifically, the diagnosis unit 4 diagnoses that the repair and reinforcement of the structure 20 were effective if the rate of occurrence of the normal natural vibration mode shape is higher than the reference value.

Diagnosis can be performed because, due to the other structure having a structure similar to that of the structure 20 being in an abnormal state before repair and reinforcement are performed on the other structure, the reference natural vibration mode shape is rarely obtained, and thus the rate of occurrence of the normal natural vibration mode shape is low. In contrast, due to the structure 20 being in a normal state after repair and reinforcement are performed on the structure 20, the rate of occurrence of the normal natural vibration mode shape is high.

[Modification 2]

Modification 2 will be described. In modification 2, the diagnosis unit 4 uses the initial rate of occurrence at the time of completion of the structure 20 as a reference value, and diagnoses whether or not repair and reinforcement of the structure 20 were effective based on this reference value and a rate of occurrence calculated after the repair and reinforcement were performed. Specifically, the diagnosis unit 4 diagnoses that the repair and reinforcement of the structure 20 were effective if the rate of occurrence of the normal natural vibration mode shape is a value equal to or close to the reference value.

Diagnosis can be performed because the initial rate of occurrence at the time of completion of the structure 20 and the rate of occurrence of the normal natural vibration mode shape after repair and reinforcement are performed on the structure 20 would be equal or similar values.

### Effects of Embodiment

As described above, according to the present example embodiment, it can be diagnosed whether or not repair and reinforcement performed on a structure were effective using rates of occurrence calculated using natural vibration mode shapes, and thus the effect of the repair and reinforcement performed on the structure can be accurately diagnosed even if the structure has high rigidity.

Furthermore, in a case in which the structure is a bridge, the effect of repair and reinforcement cannot be accurately diagnosed even if an acceleration amplitude ratio, a natural frequency, the relationship between a spectral ratio and vibration frequencies, and deflection are used. However, according to the present example embodiment, repair and reinforcement performed on a bridge can be accurately diagnosed even if the bridge has high rigidity and small deflection.

In addition, if the structure is a bridge, the diagnosis described in the present example embodiment can be applied regardless of the type of bridge. Specifically, the diagnosis described in the present example embodiment is applicable to girder bridges, suspension bridges, truss bridges, rigid-frame bridges, and the like.

In addition, if the structure is a bridge, the diagnosis described in the present example embodiment can be applied regardless of the material used in the bridge. Specifically, the diagnosis described in the present example embodiment is applicable to steel bridges, RC bridges, PC bridges, and the like.

In addition, if the structure is a bridge, the diagnosis described in the present example embodiment can be applied regardless of the type of the main girder of the bridge. Specifically, the diagnosis described in the present example embodiment is applicable to T-girder bridges, box-girder bridges, I-girder bridges, and the like.

Furthermore, since the effect of repair and reinforcement performed on a structure can be accurately diagnosed, construction for repairing and reinforcing the structure can be made more reasonable and sophisticated.

[Program]

It suffices for the program in the example embodiment of the invention to be a program that causes a computer to carry out steps A1 to A5 illustrated in FIG. 6 and steps B1 to B5 illustrated in FIG. 7. By installing this program on a computer and executing the program, the diagnosis apparatus and the diagnosis method in the present example embodiment can be realized. In this case, the processor of the computer functions and performs processing as the generation unit 2 (the section setting unit 23, the extraction unit 24, and the mode shape generation unit 25), the occurrence rate calculation unit 3, and the diagnosis unit 4.

Also, the program in the present example embodiment may be executed by a computer system formed from a plurality of computers. In this case, the computers may each function as one of the generation unit 2 (the section setting unit 23, the extraction unit 24, and the mode shape generation unit 25), the occurrence rate calculation unit 3, and the diagnosis unit 4, for example.

[Physical Configuration]

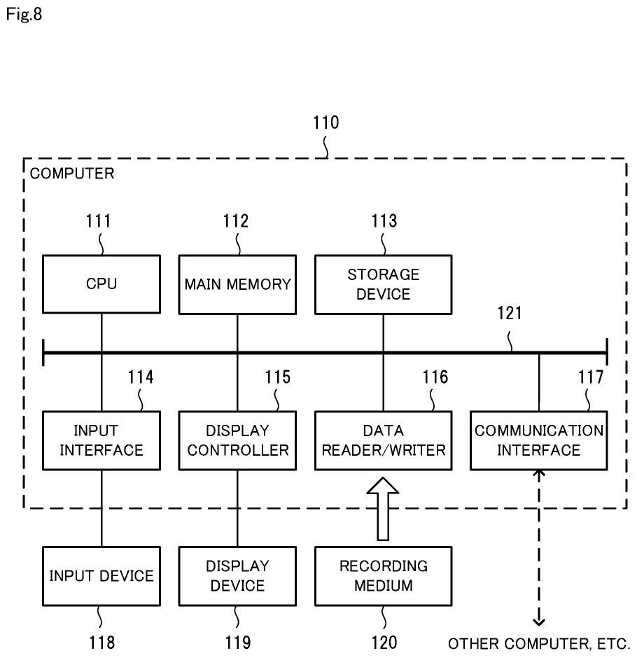

Here, a computer that realizes the diagnosis apparatus 1 by executing the program in the example embodiment will be described with reference to FIG. 8. FIG. 8 is a block diagram illustrating one example of a computer realizing the diagnosis apparatus 1 in the example embodiment of the invention.

As illustrated in FIG. 8, a computer 110 includes a CPU 111, a main memory 112, a storage device 113, an input interface 114, a display controller 115, a data reader/writer 116, and a communication interface 117. These components are connected via a bus 121 so as to be capable of performing data communication with one another. Note that the computer 110 may include a graphics processing unit (GPU) or a field-programmable gate array (FPGA) in addition to the CPU 111 or in place of the CPU 111.

The CPU 111 loads the program (codes) in the present example embodiment, which is stored in the storage device 113, onto the main memory 112, and performs various computations by executing these codes in a predetermined order. The main memory 112 is typically a volatile storage device such as a dynamic random access memory (DRAM) or the like. Also, the program in the present example embodiment is provided in a state such that the program is stored in a computer readable recording medium 120. Note that the program in the present example embodiment may also be a program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119.

The data reader/writer 116 mediates data transmission between the CPU 111 and the recording medium 120, and executes the reading of the program from the recording medium 120 and the writing of results of processing in the computer 110 to the recording medium 120. The communication interface 117 mediates data transmission between the CPU 111 and other computers.

Also, specific examples of the recording medium 120 include a general-purpose semiconductor storage device such as a CompactFlash (registered trademark, CF) card or a Secure Digital (SD) card, a magnetic recording medium such as a flexible disk, and an optical recording medium such as a compact disk read-only memory (CD-ROM).

Note that the diagnosis apparatus 1 in the present example embodiment can also be realized by using pieces of hardware corresponding to the respective units, rather than using a computer on which the program is installed. Furthermore, a part of the diagnosis apparatus 1 may be realized by using a program, and the remaining part of the diagnosis apparatus 1 may be realized by using hardware.

[Supplementary Note]

In relation to the above example embodiment, the following Supplementary notes are further disclosed. While a part of or the entirety of the above-described example embodiment can be expressed by (Supplementary note 1) to (Supplementary note 15) described in the following, the invention is not limited to the following description.

(Supplementary Note 1)

A diagnosis apparatus including:

a generation unit configured to acquire vibration information indicating vibration produced in a structure from a plurality of sensors provided to the structure, and to generate, using the vibration information, natural vibration mode information indicating a natural vibration mode shape;

an occurrence rate calculation unit configured to calculate a rate of occurrence of a normal natural vibration mode shape based on the number of times vibration was applied to the structure and the number of times the normal natural vibration mode shape was generated when the vibration was applied; and

a diagnosis unit configured to diagnose whether or not repair and reinforcement performed on the structure were effective based on the rate of occurrence and a reference value.

(Supplementary Note 2)

The diagnosis apparatus according to Supplementary note 1, wherein

the diagnosis unit uses a rate of occurrence calculated in advance before the repair and reinforcement were performed on the structure as the reference value, and diagnoses whether or not the repair and reinforcement were effective based on the reference value and the rate of occurrence calculated after the repair and reinforcement were performed.

(Supplementary Note 3)

The diagnosis apparatus according to Supplementary note 1 or 2, wherein

the natural vibration mode shape is a primary vibration mode.

(Supplementary Note 4) The diagnosis apparatus according to any one of Supplementary notes 1 to 3, wherein

the structure is a member of a multi-span structure bridge.

(Supplementary Note 5)

The diagnosis apparatus according to any one of Supplementary notes 1 to 3, wherein

the structure is a floor slab of a bridge.

(Supplementary Note 6)

A diagnosis method including:

(a) a step of acquiring vibration information indicating vibration produced in a structure from a plurality of sensors provided to the structure, and generating a natural vibration mode shape using the vibration information;

(b) a step of calculating a rate of occurrence of a natural vibration mode shape based on the number of times vibration was applied to the structure and the number of times the normal natural vibration mode shape was generated when the vibration was applied; and

(c) a step of diagnosing whether or not repair and reinforcement performed on the structure were effective based on the rate of occurrence and a reference value.

(Supplementary Note 7)

The diagnosis method according to Supplementary note 6, wherein

in the (c) step, a rate of occurrence calculated in advance before the repair and reinforcement were performed on the structure is used as the reference value, and it is diagnosed whether or not the repair and reinforcement were effective based on the reference value and the rate of occurrence calculated after the repair and reinforcement were performed.

(Supplementary Note 8)

The diagnosis method according to Supplementary note 7 or 8, wherein

the natural vibration mode shape is a primary vibration mode.

(Supplementary Note 9)

The diagnosis method according to any one of Supplementary notes 7 to 9, wherein

the structure is a member of a multi-span structure bridge.

(Supplementary Note 10)

The diagnosis method according to any one of Supplementary notes 7 to 9, wherein

the structure is a floor slab of a bridge.

(Supplementary Note 11)

A computer readable recording medium that includes a program recorded thereon, the program causing a computer to carry out:

(a) a step of acquiring vibration information indicating vibration produced in a structure from a plurality of sensors provided to the structure, and generating a natural vibration mode shape using the vibration information;

(b) a step of calculating a rate of occurrence of a natural vibration mode shape based on the number of times vibration was applied to the structure and the number of times the normal natural vibration mode shape was generated when the vibration was applied; and

(c) a step of diagnosing whether or not repair and reinforcement performed on the structure were effective based on the rate of occurrence and a reference value.

(Supplementary Note 12)

The computer readable recording medium according to Supplementary note 11, wherein

in the (c) step, a rate of occurrence calculated in advance before the repair and reinforcement were performed on the structure is used as the reference value, and it is diagnosed whether or not the repair and reinforcement were effective based on the reference value and the rate of occurrence calculated after the repair and reinforcement were performed.

(Supplementary Note 13)

The computer readable recording medium according to Supplementary note 11 or 12, wherein the natural vibration mode shape is a primary vibration mode.

(Supplementary Note 14)

The computer readable recording medium according to any one of Supplementary notes 11 to 13, wherein

the structure is a member of a multi-span structure bridge.

(Supplementary Note 15)

The computer readable recording medium according to any one of Supplementary notes 11 to 13, wherein

the structure is a floor slab of a bridge.

The invention has been described with reference to an example embodiment above, but the invention is not limited to the above-described example embodiment. Within the scope of the invention, various changes that could be understood by a person skilled in the art could be applied to the configurations and details of the invention.

### INDUSTRIAL APPLICABILITY

As described above, according to the invention, a structure can be accurately diagnosed. Furthermore, the invention is useful in fields in which structures are accurately diagnosed. For example, if the structure is a bridge, the invention is useful regardless of the type of bridge, and is useful for the diagnosis of girder bridges, suspension bridges, truss bridges, rigid-frame bridges, and the like. In addition, the invention is useful regardless of the material used in the bridge, and is useful for the diagnosis of steel bridges, RC bridges, PC bridges, and the like. Furthermore, the invention is useful regardless of the type of main girder of the bridge, and is useful for the diagnosis of T-girder bridges, box-girder bridges, I-girder bridges, and the like.

### REFERENCE SIGNS LIST

1 Diagnosis apparatus
2 Generation unit
3 Occurrence rate calculation unit
4 Diagnosis unit
20 Structure
21 Sensors
22 Collection unit
23 Section setting unit
24 Extraction unit
25 Mode shape generation unit
30 Vehicle
110 Computer
111 CPU
112 Main Memory
113 Storage device
114 Input interface
115 Display controller
116 Data reader/writer
117 Communication interface
118 Input equipment
119 Display device
120 Recording medium
121 Bus

What is claimed is:

1. A diagnosis apparatus comprising:
a generation unit configured to acquire vibration information indicating vibration produced in a structure from a plurality of sensors provided to the structure, and to generate, using the vibration information, natural vibration mode information indicating a natural vibration mode shape;
an occurrence rate calculation unit configured to calculate a rate of occurrence of a normal natural vibration mode shape based on the number of times vibration was applied to the structure and the number of times the normal natural vibration mode shape was generated when the vibration was applied; and
a diagnosis unit configured to diagnose whether or not repair and reinforcement performed on the structure were effective based on the rate of occurrence and a reference value.

2. The diagnosis apparatus according to claim 1, wherein
the diagnosis unit uses a rate of occurrence calculated in advance before the repair and reinforcement were performed on the structure as the reference value, and diagnoses whether or not the repair and reinforcement were effective based on the reference value and the rate of occurrence calculated after the repair and reinforcement were performed.

3. The diagnosis apparatus according to claim 1, wherein
the natural vibration mode shape is a primary vibration mode.

4. The diagnosis apparatus according to claim 1, wherein
the structure is a member of a multi-span structure bridge.

5. The diagnosis apparatus according to claim 1, wherein
the structure is a floor slab of a bridge.

6. A diagnosis method comprising:
acquiring vibration information indicating vibration produced in a structure from a plurality of sensors provided to the structure, and generating a natural vibration mode shape using the vibration information;
calculating a rate of occurrence of a normal natural vibration mode shape based on the number of times vibration was applied to the structure and the number of times a normal natural vibration mode shape was generated when the vibration was applied; and
diagnosing whether or not repair and reinforcement performed on the structure were effective based on the rate of occurrence and a reference value.

7. The diagnosis method according to claim 6, wherein
in the diagnosing, a rate of occurrence calculated in advance before the repair and reinforcement were performed on the structure is used as the reference value, and it is diagnosed whether or not the repair and reinforcement were effective based on the reference value and the rate of occurrence calculated after the repair and reinforcement were performed.

8. The diagnosis method according to claim 6, wherein
the natural vibration mode shape is a primary vibration mode.

9. The diagnosis method according to claim 6, wherein
the structure is a member of a multi-span structure bridge.

10. The diagnosis method according to claim 6, wherein
the structure is a floor slab of a bridge.

11. A non-transitory computer readable recording medium that includes a program recorded thereon, the program causing a computer to carry out:
acquiring vibration information indicating vibration produced in a structure from a plurality of sensors provided to the structure, and generating a natural vibration mode shape using the vibration information;
calculating a rate of occurrence of a normal natural vibration mode shape based on the number of times vibration was applied to the structure and the number of times a normal natural vibration mode shape was generated when the vibration was applied; and
diagnosing whether or not repair and reinforcement performed on the structure were effective based on the rate of occurrence and a reference value.

12. The non-transitory computer readable recording medium according to claim 11, wherein
in the diagnosing, a rate of occurrence calculated in advance before the repair and reinforcement were performed on the structure is used as the reference value, and it is diagnosed whether or not the repair and reinforcement were effective based on the reference value and the rate of occurrence calculated after the repair and reinforcement were performed.

13. The non-transitory computer readable recording medium according to claim 11, wherein
the natural vibration mode shape is a primary vibration mode.

14. The non-transitory computer readable recording medium according to claim 11, wherein
the structure is a member of a multi-span structure bridge.

15. The non-transitory computer readable recording medium according to claim 11, wherein
the structure is a floor slab of a bridge.
